(19) United States
(12) Patent Application Publication
(10) Pub. No.: US 2004/0143512 A1
(43) Pub. Date: Jul. 22, 2004

(54) Method and system for placing an order

(76) Inventor: Paul Edward Sturr JR., Rochester Hills, MI (US)

Correspondence Address: DICKINSON WRIGHT PLLC, 1901 L. STREET NW, SUITE 800, WASHINGTON, DC, 20036, US

(21) Appl. No.: 10/695,542

(22) Filed: Oct. 28, 2003

Related U.S. Application Data
(60) Provisional application No. 60/422,002, filed on Oct. 28, 2002.

(51) Int. Cl. G06F 17/60

(52) U.S. Cl. 705/26; 705/15

(57) ABSTRACT

The present invention relates to a system and method for ordering an item including the use of a dynamic imaging and dynamic texting display having a hub and spoke arrangement for arranging a company's items offered for sale. The present invention further includes the use of a display having a register receipt tabulated arrangement for arranging selected items in response to a performance of at least one action of the customer. The display can be incorporated into a kiosk that is adapted to receive input from a user or customer.

### BACKGROUND OF THE INVENTION

The present invention relates to Point of Sale (“POS”) systems having been commonly implemented with proprietary cash register machines linked through a communications network to one or more background servers. POS systems provide an efficient manner for receiving customer order entry information and for communicating such customer order entry information to a company's order preparation function and to a company's sales function.

In the past, POS systems have required the use of expensive and inefficient server systems and software. These POS systems typically include software written specifically for a company's product line and as such are not easily modified. These POS systems are not well suited to many applications, including fast food, takeout quick serve restaurants, where frequent modifications of the menu are required. Many POS server systems require expensive servers located at the company's facility where the customer enters an order.

Other potential problems with POS systems include interfaces that are difficult for potential purchasers to navigate without prior familiarity. In certain applications, such as fast food, the required interface becomes more complex and the display of items more complex due to increased choices and often customized items to satisfy a particular purchaser's needs.

### SUMMARY OF THE INVENTION

The present invention relates to a system and method for ordering an item including the use of a dynamic imaging and dynamic texting display having a hub and spoke arrangement for arranging a company's items offered for sale. The present invention further includes the use of a display having a register receipt tabulated arrangement for arranging selected items in response to a performance of at least one action of the customer. The display can be incorporated into a kiosk that is adapted to receive input from a user or customer.

The present invention provides many benefits and advantages over the prior POS systems by providing a dynamic imaging and dynamic texting display. Such a display permits a company offering items for sale to easily modify their offered items on the display. Also, the hub and spoke arrangement organizes the company's items for sale in a simple manner for use by the purchaser and the register receipt tabulated arrangement permits a useful summary of a customer's order. It also permits easy modifications to a customer's order.

The present invention is ideally suited for the quick service industry such as fast food, coffee houses, theme parks, malls, stadiums, universities and colleges, but can be used in other industries where self service transactions are possible.

Further scope of applicability of the present invention will become apparent from the following detailed description, claims, and drawings. However, it should be understood that the detailed description and specific examples, while indicating preferred embodiments of the invention, are given by way of illustration only, since various changes and modifications within the spirit and scope of the invention will become apparent to those skilled in the art.

### BRIEF DESCRIPTION OF THE DRAWINGS

The present invention will become more fully understood from the detailed description given here below, the appended claims, and the accompanying drawings in which:

FIG. 1 illustrates a kiosk user interface or display prior to a client input;

FIG. 2 illustrates a kiosk user interface of FIG. 1 after client input having a hub and spoke arrangement of multiple categories of items offered for sale and an order summary;

FIG. 3 illustrates a kiosk user interface having a hub and spoke arrangement of category items from one of the multiple categories of items offered for sale in FIG. 2, as well as an order summary;

FIG. 4 illustrates a kiosk user interface having a hub and spoke arrangement of customization item options for the selected category item from FIG. 3, as well as an order summary;

FIG. 5 illustrates a kiosk user interface having a hub and spoke arrangement of customization item options for further customizing the selected customization item option from FIG. 4, as well as an order summary;

FIG. 6 illustrates another exemplary kiosk user interface having a hub and spoke arrangement of customization item options for the selected category item from FIG. 3, as well as an order summary;

FIG. 7 illustrates another exemplary kiosk user interface having a hub and spoke arrangement of customization item options for the selected category item from FIG. 3, as well as an order summary;

FIG. 8 illustrates another exemplary kiosk user interface having a hub and spoke arrangement of customization item options for the selected category item from FIG. 3, as well as an order summary;

FIG. 9 illustrate a kiosk user interface having a hub and spoke arrangement of customization item options for the selected customization item from FIG. 8;

FIG. 10 illustrates a kiosk user interface having a hub and spoke arrangement and a register receipt tabulation;

FIG. 11 illustrates a kiosk user interface having a hub and spoke arrangement and a register receipt tabulation;

FIG. 12 illustrates a kiosk user interface showing a suggested item that will round up the order total to an even dollar amount;

FIG. 13 illustrates a kiosk user interface having a register receipt tabulation and an indication the order is being processed;

FIG. 14 illustrates one embodiment of a system of the present invention comprising a kiosk user interface, a POS register and a preparation monitor;

FIG. 15 illustrates a second embodiment of a system of the present invention; and

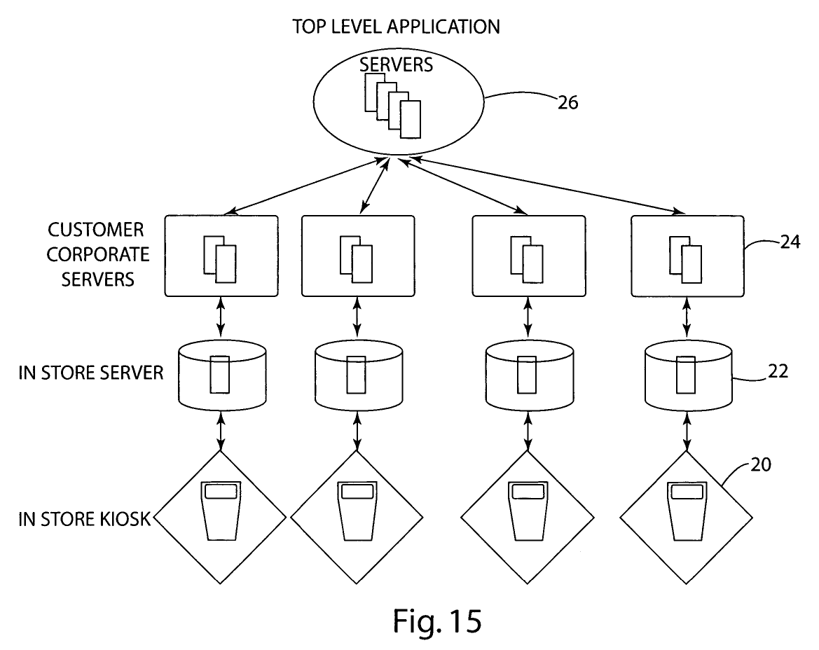

FIG. 16 illustrates a flow chart of exemplary method steps.

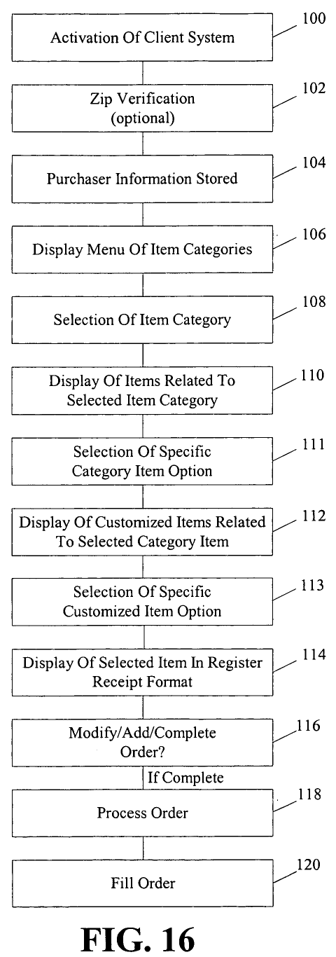

### DETAILED DESCRIPTION OF THE PREFERRED EMBODIMENT

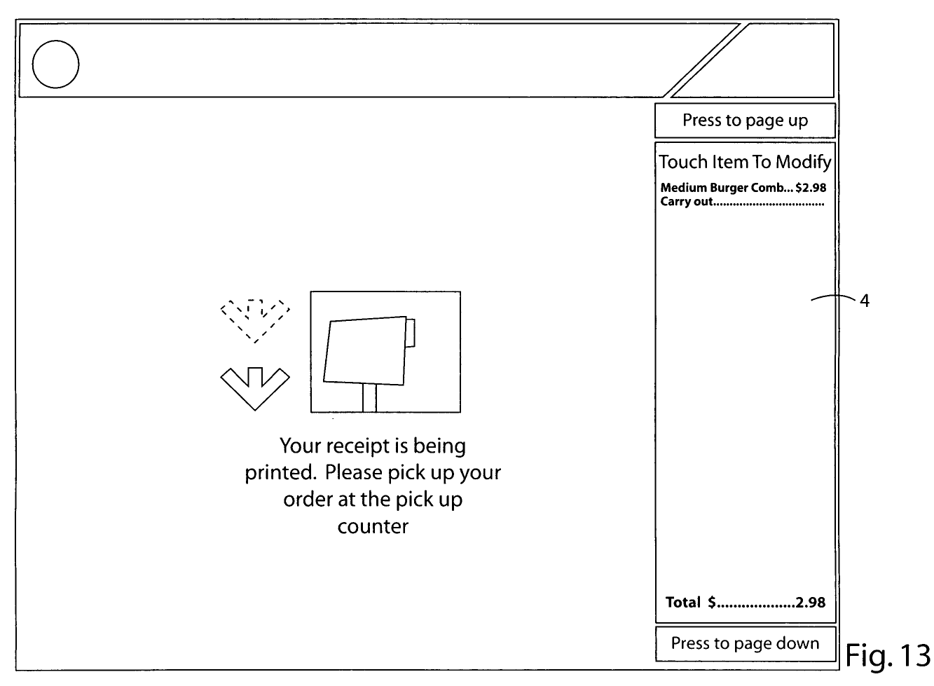

The present invention relates to Point of Sale (“POS”) systems having been commonly implemented with proprietary cash register machines linked through a communications network to one or more background servers. POS systems provide an efficient manner for receiving customer order entry information and for communicating such customer order entry information to a company's order preparation function and to a company's sales function. The present invention provides a system and method for ordering an item from a kiosk user interface including the use of a dynamic imaging and dynamic texting display having a hub and spoke arrangement for arranging a company's items offered for sale. The present invention further comprises a kiosk user interface including the use of a register receipt tabulated arrangement for arranging and displaying selected items in response to the performance of at least one selection action of the customer. FIG. 13 illustrates a kiosk user interface typically located for customer interaction. The kiosk user interface can display any information, including information which is related to the POS transaction or other information which the vendor wishes to display. POS information may comprise information about a company's products, promotional information, order status and other customer relevant information. Kiosk user interfaces 20 are usually offered with touch screens 28 for the customer to enter information by touching a monitor screen, however, other means for entering information may also be used, including keyboards, touch panels, pen input devices, joysticks, mice, microphones and voice recognition and response systems and other suitable means of making a selection that can be recognized by a computer. The kiosk 20 in FIG. 13 shows a system of the present invention comprising a kiosk user interface in signal communication with a POS register and a preparation monitor, shown here as a kitchen monitor 19. These devices are in signal communication with one another using known methods such as serial communication, a local area network or a wide area network. The communication may be through wired connections, wireless connections or combinations thereof. The kiosk user interface 20 is preferably the order input device and is adapted to receive input from a user or purchaser. The input received at the kiosk user interface is then available for communication to and display at the other devices. The kiosk user interface 20 utilizes dynamic images and text using known programming methods for providing the same. The display means may comprise a cathode ray tube (CRT), plasma, liquid crystal display (LCD) or any other suitable display means. Dynamic imaging and dynamic text allow the user interface display to be reconfigured automatically as the change content of the associated database is changed. All images and text are stored in the database. Anytime a new item is added or a change is made, the user interface changes to reflect the change without the necessity of recompiling or recoding the software used to generate the display. The kiosk user interface 20 may also comprise a computer that is adapted to host the database, receive input from and provide output to the display, communicate with the other devices of the system and perform dynamic imaging and dynamic texting in response to the inputs received as described herein.

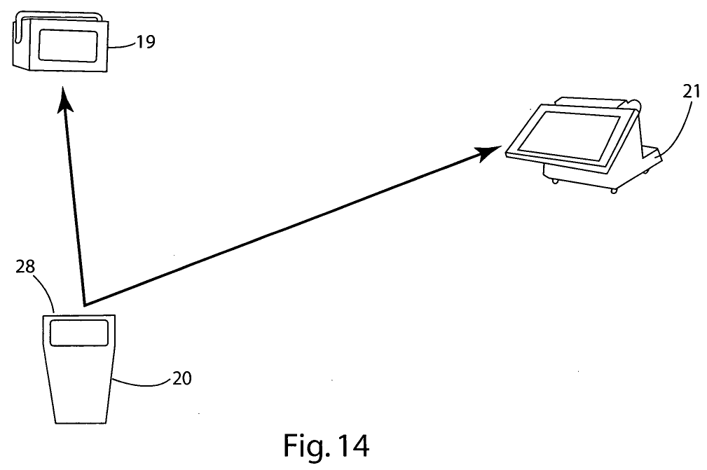

FIG. 14 illustrates another embodiment of the invention comprising a client and server computer configuration. The application that performs the dynamic imaging and dynamic texting is server-based meaning the application and the database run on a computer server 72 rather than the kiosk or client 20. The user interface the customer sees is a “thin client” which primarily has the resources necessary to receive input from a user or customer and display the information from the database. This allows the application to be run with less hardware resources. This also allows the application to be easily web-enabled and run on handheld pc's and PDA's. Information representing the products may be automatically updated from a central server 26. As shown in FIG. 14, the kiosk user interface 20 is linked may be with a smaller company store server 22 which is in turn linked to a company's corporate server 24 and from there to a final server, such as an application server 26. Additionally, each kiosk 20 has the capability to notify an administrator, such as a network administrator, of problems or errors that occur. In the store, the kiosks 20 may be connected via a secure wireless network, such as a network operating on 802.11b protocol. All data may be encrypted, and preferably is double encrypted using the standard secure socket layer SSL and a proprietary encryption logarithm. The store server 22 may be adapted to store information related to specific store requirements, such as those which are based on particular demographic requirements of the company store. The individual store servers 22 can be connected, using standard phone lines, DSL, Cable or high speed dedicated lines such as T-1, to a corporate server 24. The corporate server 24 may be utilized to connect with a plurality of store servers 22 in order to create, for example, total corporate information on all sold items from all stores, or for single store sales information only. The final or top level application server 26, such as an application server, is shown in order to demonstrate that upgrades or repairs to the system can be done remotely so that a visit to each company location is not required.

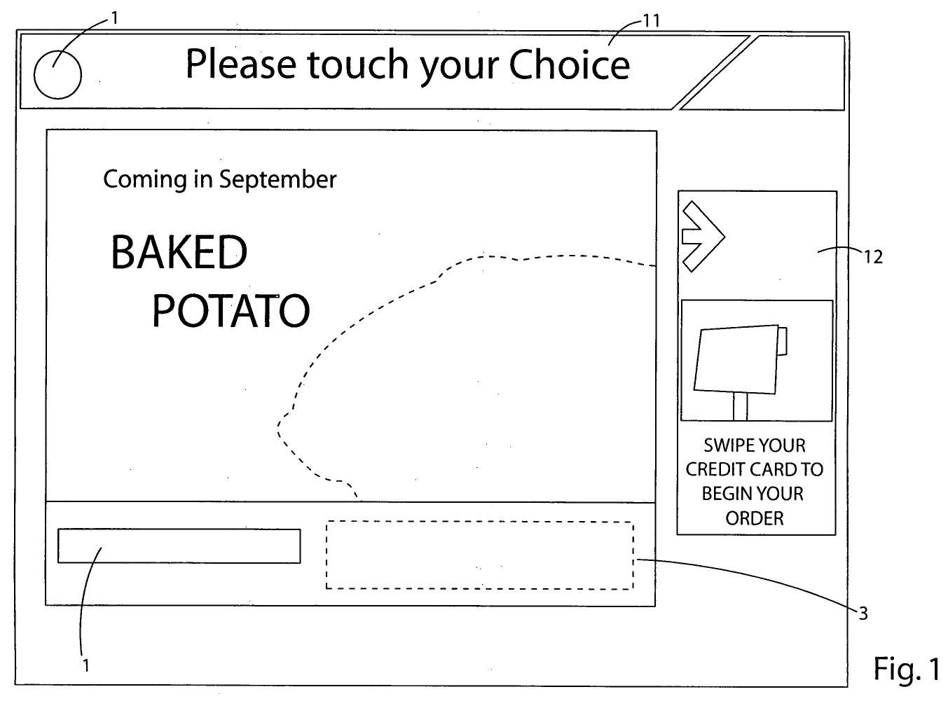

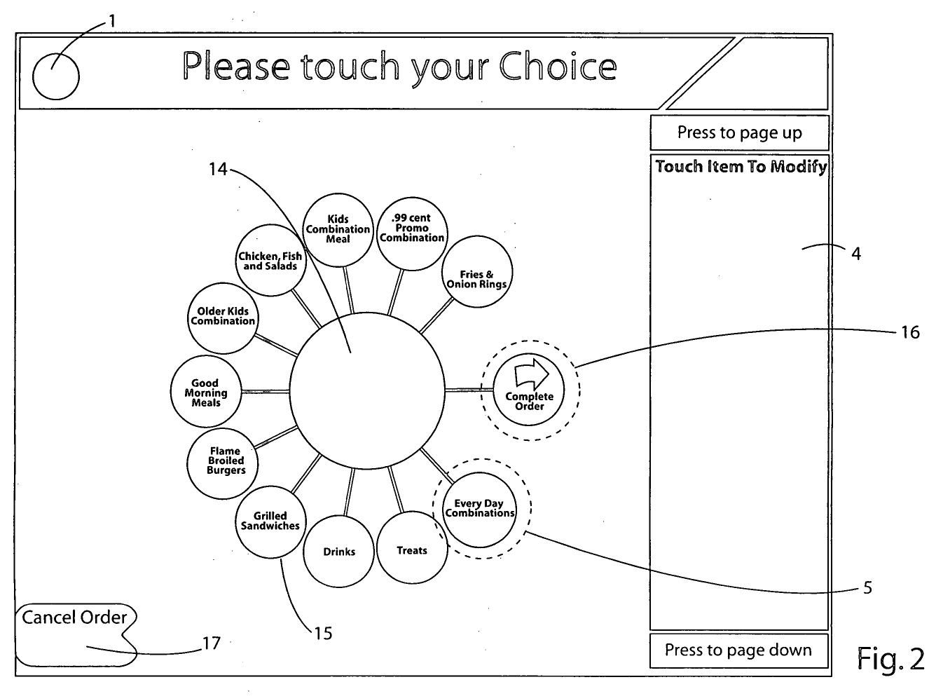

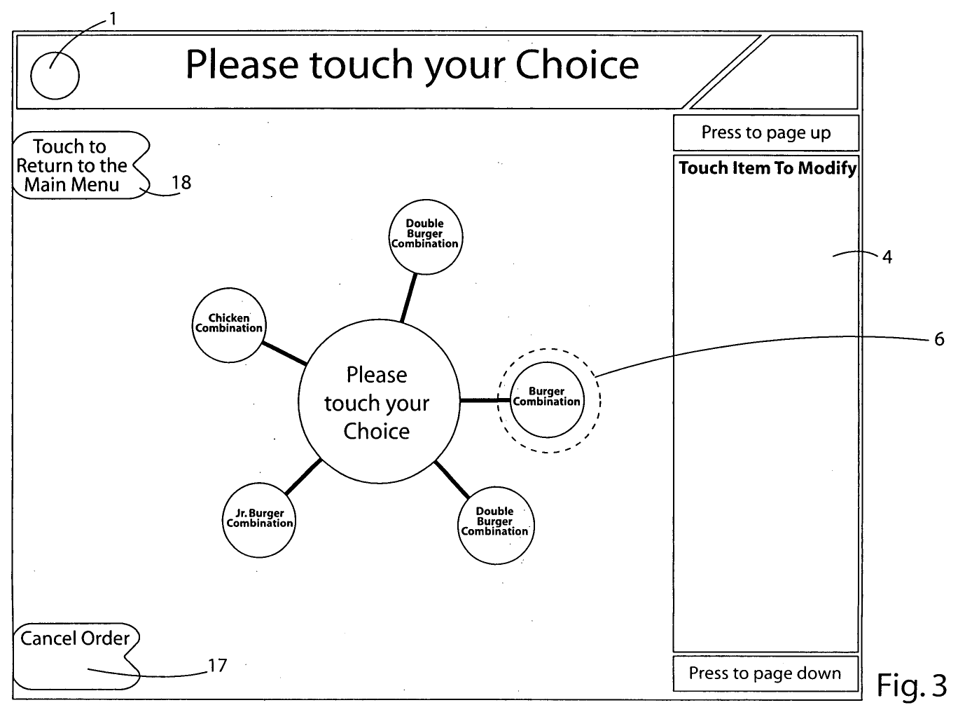

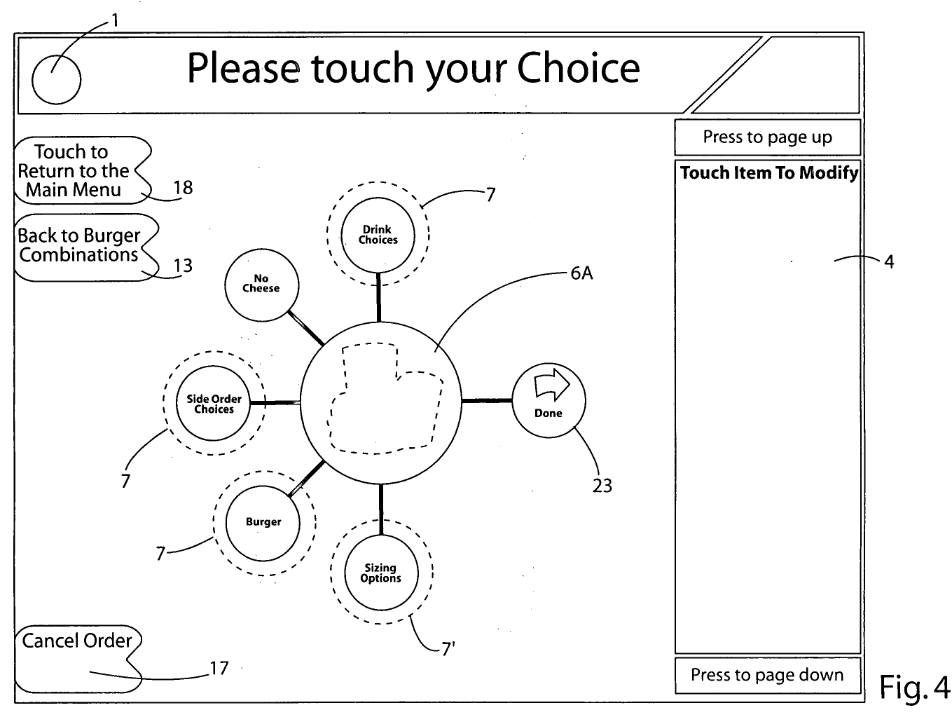

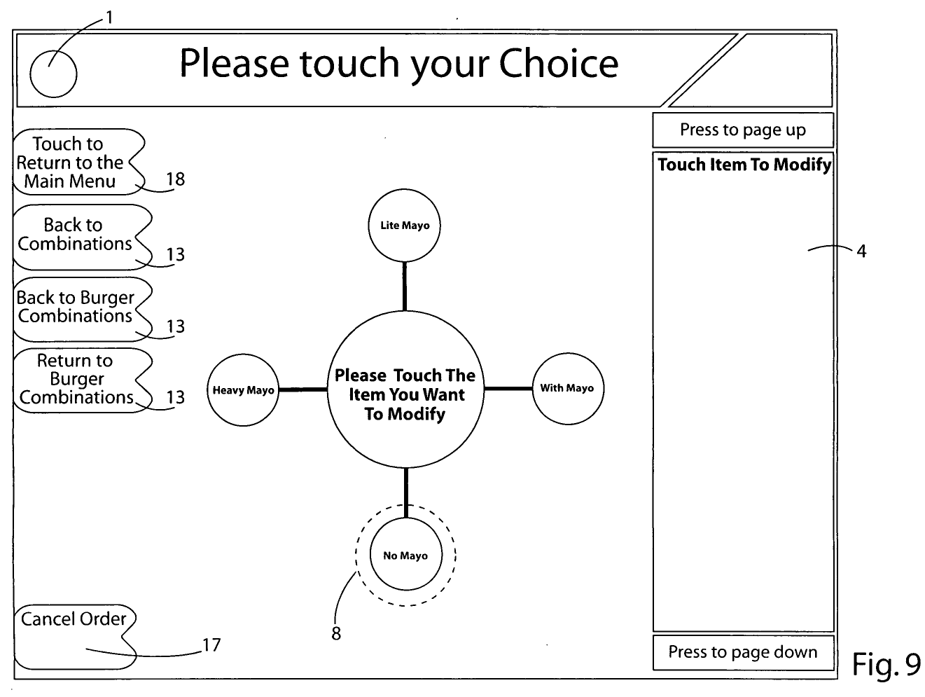

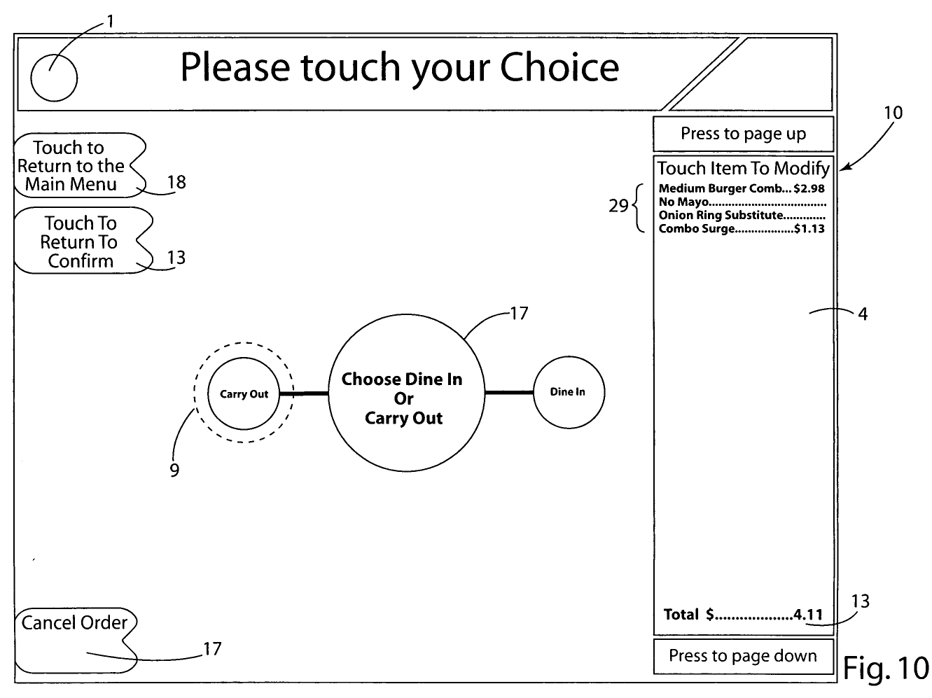

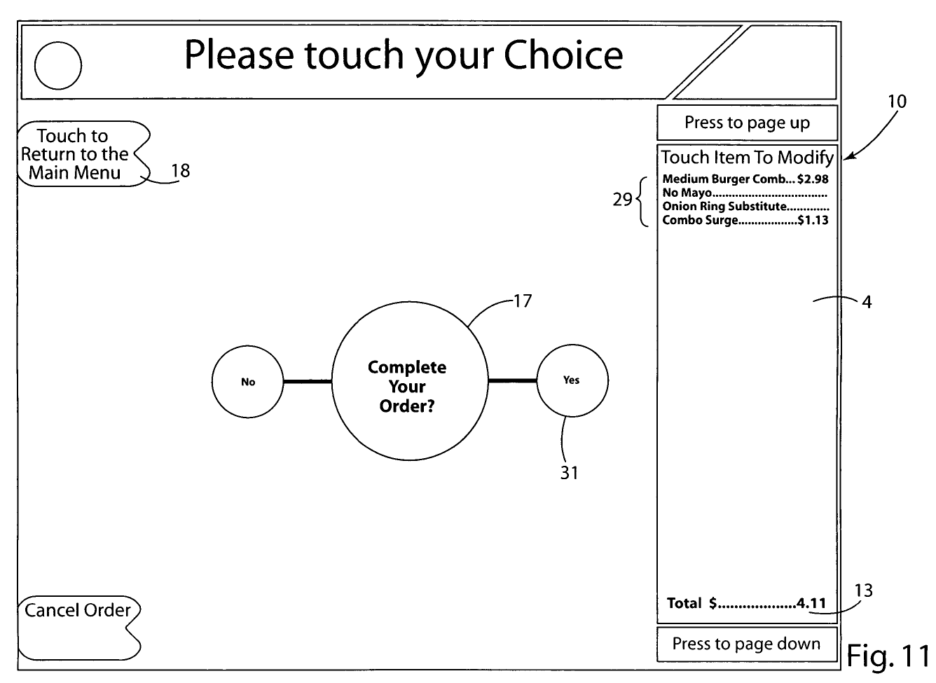

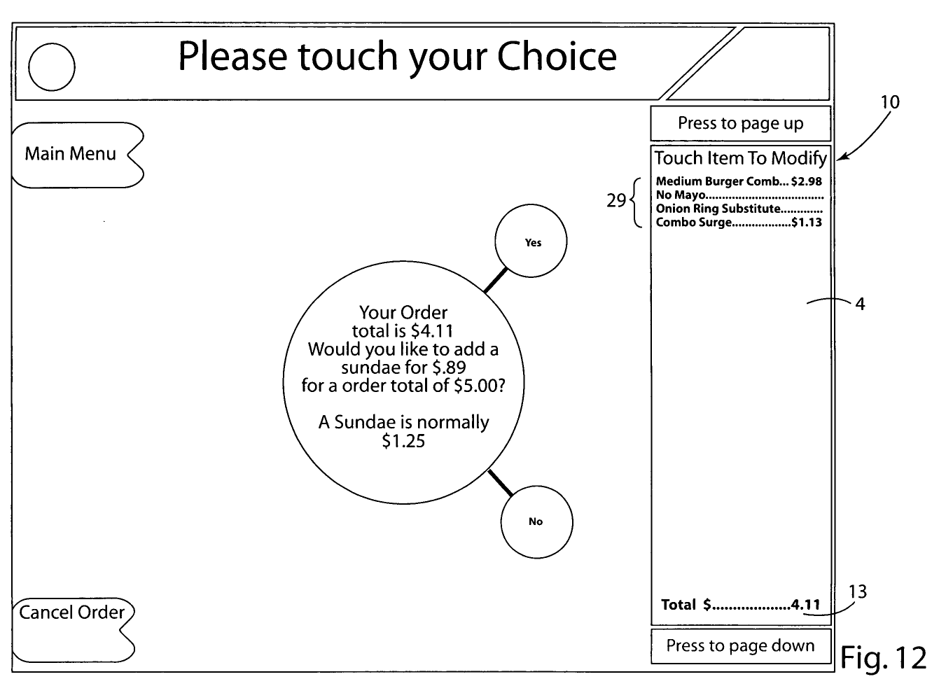

In operation, a customer enters an order via a touch screen which can also display company promotional information as shown in FIG. 1. To activate the system preferably a credit, debit or other approved specialty card may be swiped or inserted, or other suitable activation means employed to initiate the transaction (Step 100). This means may be sufficient to provide complete authorization or payment for the POS transaction, or it may simply provide information sufficient to uniquely identify the POS transaction, such that an alternate means of final authorization or payment may be employed. A further optional step is the secondary verification using the zip code attached to the card (Step 102). Once the system has been activated, the information read from the card is cached or stored (Step 104). The customer is then presented with a menu configured in the form of wheel with spokes as shown in FIG. 2 (Step 106). Typically, the information presented in these spokes would represent the broadest selection choices or categories. The customer then makes a choice by touching the spoke representing the choice at this level (Step 108). Based on the choice, different lower level menus appear which are dependent on and associated with the previous choice, as shown in FIGS. 3-9 (Step 110). Scrolling instructions associated with the screen can be seen at all times in the gray box at the top of the screen. For example, if a customer chooses a combination meal, only combination meal options are listed. Once a specific combination meal is selected, the next menu contains only choices associated with that particular combination meal as shown in FIG. 4 (Step 112). After a single order has been placed, a single order being either a single item such as a hamburger or a complete combination meal that may comprise a combination of items, it is displayed to the right on the virtual cash register receipt 40 and a colored tab 29 is created to identify the order in case a modification is necessary after the initial entry, as shown in FIGS. 10-12 (Step 114). If modifications to the order are necessary, the customer simply touches the tab 29 associated with the order that needs modification and is taken back to the proper screen to make changes to the order (Step 116). The system then prompts the customer to complete, modify or add items to the total order. If the order is complete, the user selects the spoke representing “Yes” 31 as shown in FIG. 11, and the total dollar amount is processed in real time using cached or stored authorization information from the card (Step 118). Alternately, the order could then be passed to a human operator or a currency collection/disbursement machine to complete the authorization or payment. The total time to process the stored information is approximately 3 seconds. If approved, the order is given a number and sent directly to the kitchen to be filled and the customer is notified of the processing as shown in FIG. 12 (Step 120). A receipt prints detailing the order number, all items including additions and deletions such as “no mayo” or “extra pickles.” If the order is not approved, a friendly message may be displayed asking the customer to please place their order with the cashier.

While the customer is placing an order, several things are going on in the background. A number is being picked from the master database on the POS system to be assigned to this order so that it is inserted in the correct order to be prepared. The order is being sent to the KVS (Kitchen Video System) 19, either as the customer orders each item or once the entire order has been completed. This is a local choice made by each user establishment in conjunction with the system setup. The KVS 19 plays a pivotal role in that if a store is currently equipped with monitors in the kitchen, such as most fast food establishments, an interface to the KVS unit must be used. If the establishment does not currently have a monitor system in the preparation area, such as Starbucks, monitors need to be installed. Once the order reaches the monitors in the food preparation area, orders are cleared using a “bump bar” (not shown). The “bump bar” is a number keypad that clears the orders from the monitor once it has been filled. At the same time, the information associated with the transaction is being collected and stored. Relevant information such as transaction amount and items ordered may be transferred to the reporting software used by the establishment. Other information that is collected is available from the internal reporting software built into Walk Up Systems software. More detailed information such as demographic and trends information is also collected and is available utilizing an optional data collection module.

Other embodiments of the present invention may include an intelligent up-selling module. In this module, after an order has been completed the system prompts the user to add items to their order based on selections already ordered. The offer will always make the total an exact whole dollar amount, as illustrated in FIG. 12. (Ex. The order total $5.65. If the order contains a kids meal, an additional item may be a kids ice cream cone and an offer will be made for $0.35 to make the new total an even $6.00, even though the regular price may be $0.50. The decision concerning the offer price is made based on actual costs and a logarithm. Another embodiment may include coupons on the printed receipt generated by the system and for use at the time of their next order. Each such coupon offering may be designed by each company with the use of the present invention. Another embodiment may include gathering all information by the system using a data collection module allowing the administrator to easily create custom reports with graphs and trends to aid the owners in critical business decisions and offers that affect each individual store. Another embodiment may include a specialty card module allowing the system to accept, create and administer the acceptance of specialty cards and loyalty programs. The system has the ability to keep information and histories of orders, totals, visits and points or dollars values good toward awards or merchandise. This can speed up the transaction time by up to 50%. This module also allows the store to create gift cards and recharge the card value when depleted. Also, the present invention may be adapted for use with the internet thereby permitting customers to have the ability to enter and pay for orders directly from a remote location.

An exemplary method related to a fast food system will be described in greater detail with reference to the figures. An exemplary initial display is illustrated in FIG. 1. The display will typically include permanent instruction box 11 and a temporary instruction box 12. Due to the dynamic nature of the system, trademarks, logos, and other establishment information 1 may easily be changed through the web or in the store. Advertising space 3 may also be provided on the initial display screen as illustrated in FIG. 1 and easily changed due to the dynamic nature of the images and text. In FIG. 1, the temporary instruction box 12 prompts the user to swipe a card such as a credit card to activate the system.

Upon the user swiping the card having purchaser identifiable information (Step 100) the display provides a display of selected items related to item categories as illustrated in FIG. 2 (Step 106). The system displays the item categories 5 in a hub 14 and spoke 15 arrangement with the item categories 5 arranged on the spokes 15. Other command buttons may be included on the spokes 15, such as the order complete button 16 illustrated in FIG. 2. The order complete button 16 may optionally appear only once an item is selected and appears in the order summary 4. The display may include other command buttons to easily allow the user to move about various menus, such as the illustrated cancel order button 17 to allow the purchaser to cancel the order and return to the initial display screen illustrated in FIG. 1.

The user then selects an item category from the displayed item categories by touching the specific item category 5 on the screen in a predetermined location (Step 108). In the example illustrated in FIGS. 2 and 3, the user selects the everyday combinations. The everyday combination category is then displayed as illustrated in FIG. 3 with category item options 6 on the spokes 15 extending from the hub 14 (Step 110). If the user selects the wrong category and wishes to return them to the main menu, the user may press the return to main menu button 18. In the present example, the system displays everyday combinations and the user selects the burger combination category item option 6 (Step 111).

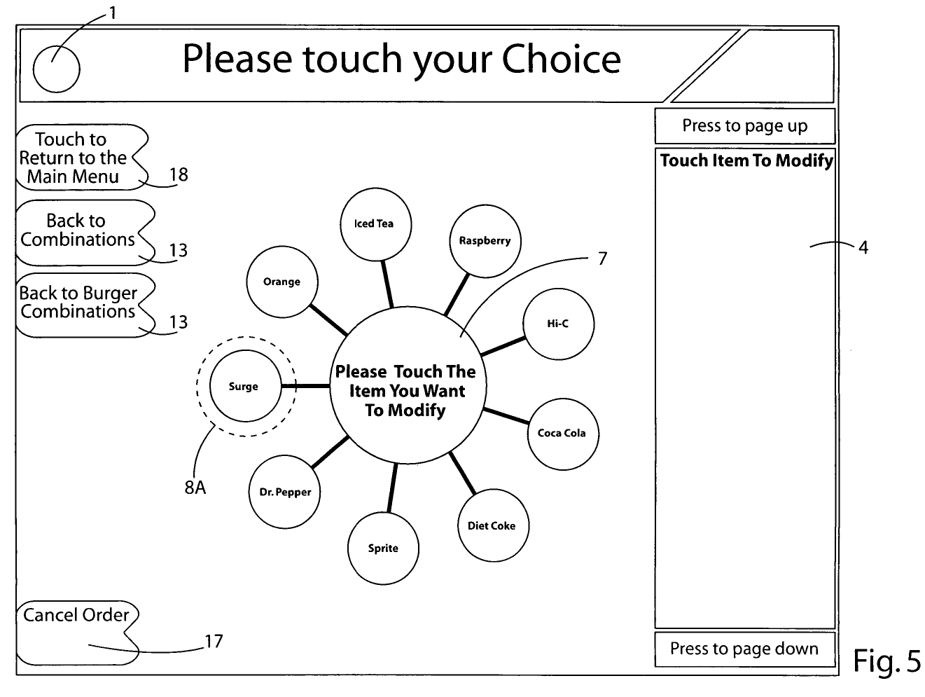

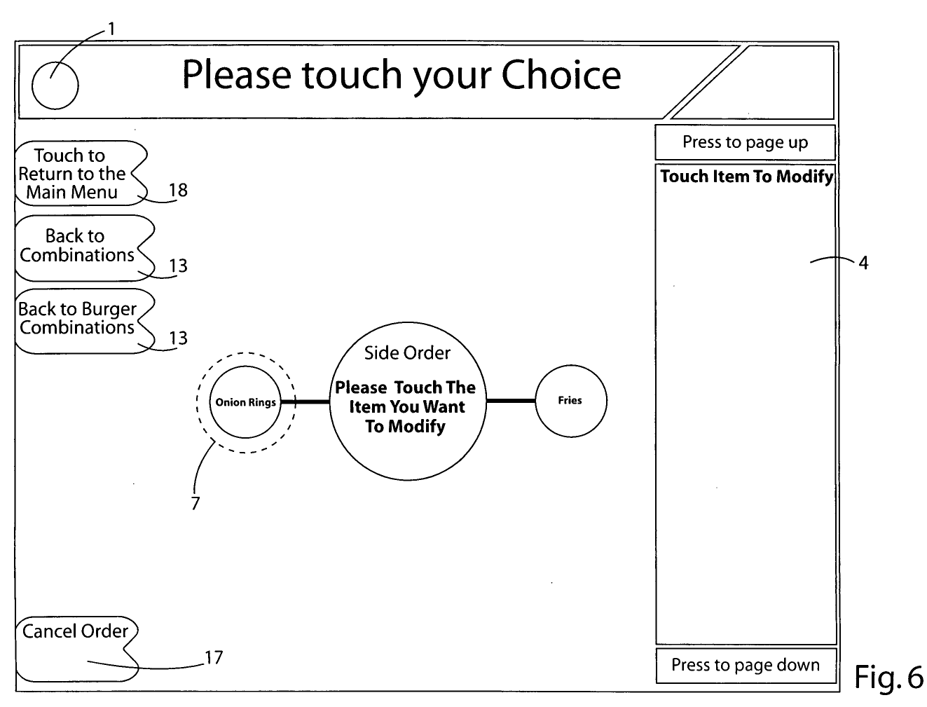

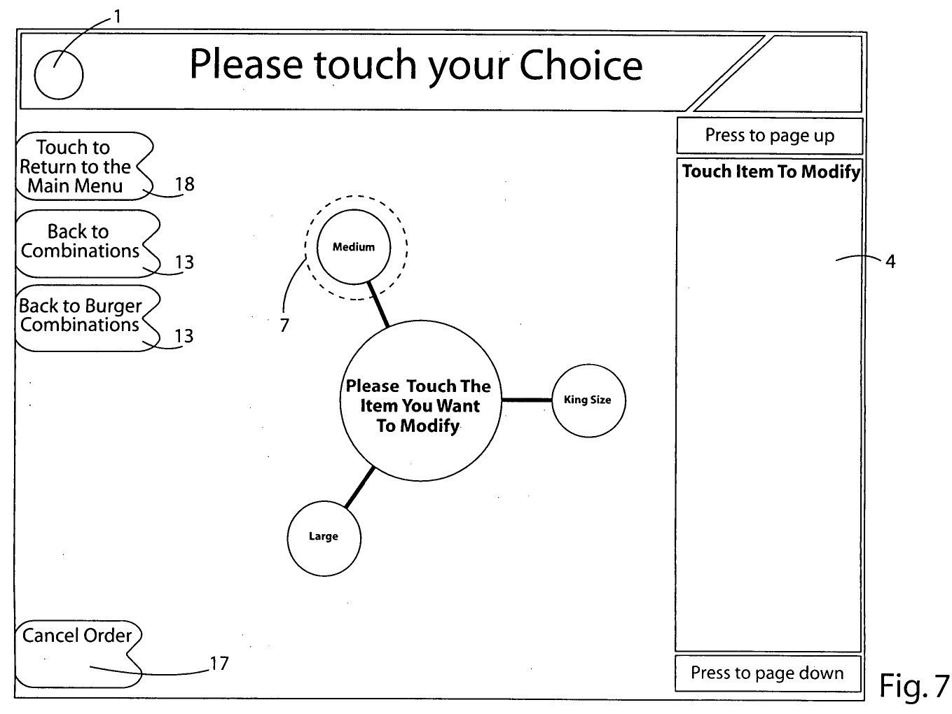

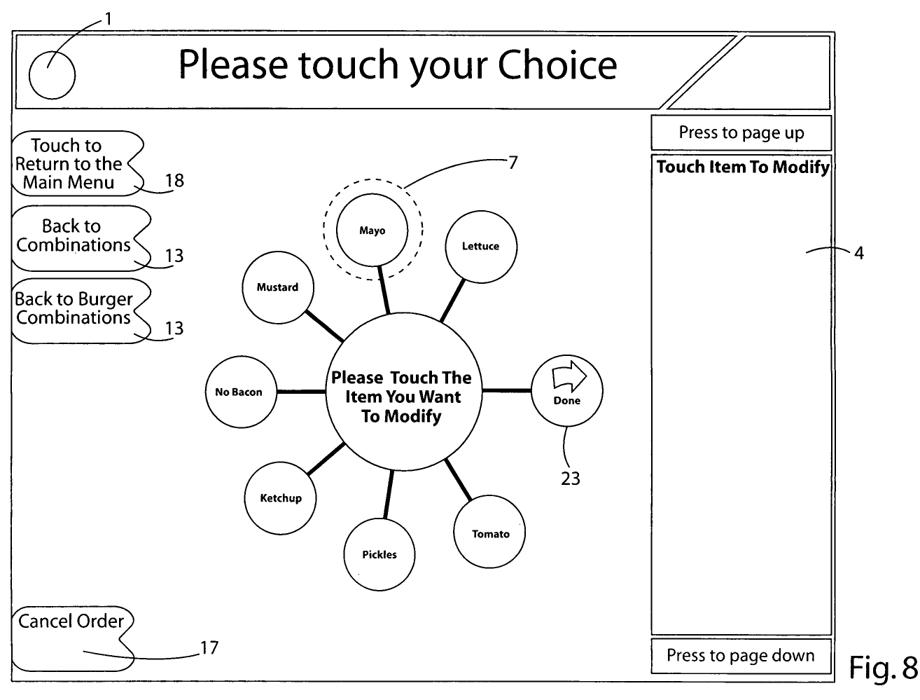

In response to the user selecting a specific category item option 6, customized item options 7 are displayed on the spokes 15 and the selected category item 6a may be displayed on the hub 14 (Step 112). The user then selects the customization item 7 (Step 113) which may cause the system to display a sublevel menu related to the selected customization item 7 for further selection. In the illustrated embodiment shown in FIGS. 4 and 5, the user selects drink choices which causes the system to display a variety of drink related sub-customization item options 8. The user the selects Surge 8a for the drink option which may be entered immediately into the order summary 4 or entered as a combination item once all parts of the combination item are selected. On certain menus and submenus, menu level buttons 13 may appear allowing the user to return to a previous menu level when an item or menu is selected by mistake without canceling the order. Based on the last selected item, the system may prompt the user to select the next choice such as the illustrated selection in FIG. 6 or return the user to the menu shown in FIG. 4 to complete selections of all items related to selected category item 6. In the embodiment illustrated in FIG. 6, the user selects onion rings which are added to the system database along with the previously selected Surge for display later in the order summary 4. The menus may be linked based on the selected drink and side order choices to prompt the user to select the size of the selected items, as illustrated in FIG. 7, or return the user to the customization item options illustrated in FIG. 4. If the purchaser or user desired special requests regarding the preparation of their items, these requests may be selected as illustrated in FIG. 8.

After selecting the items as illustrated above, the user may select the done button 23, illustrated in FIGS. 4 and 8, to prompt the system to complete the order. The system may then prompt for specific consumer choices such as the illustrated dine-in or carry out options in FIG. 10. With the user selecting the done button 23, the selected item 10 appears in the order summary 4 and a total 13 may be provided (Step 114). A modify button 29 may also appear to allow the user to modify a completed order (Step 116). If the order is complete, the user may select the yes option from FIG. 11 to complete the order.

As illustrated in FIG. 12, the user may be offered a suggested item based on the order in the order summary 4 to round off the order total to an even dollar amount. As illustrated in FIG. 13, upon completing the order the system may display instructions on where to pick up the order, how to pay for the order, and the printing of a receipt.

The foregoing discussion discloses and describes an exemplary embodiment of the present invention. One skilled in the art will readily recognize from such discussion, and from the accompanying drawings and claims that various changes, modifications and variations can be made therein without departing from the true spirit and fair scope of the invention as defined by the following claims.

What is claimed is:

1. A client system for ordering an item comprising:
a client input for receiving client data:
a dynamic imaging and dynamic texting display for simultaneously displaying selection items in a hub and spoke arrangement and selected items in a register receipt tabulated arrangement;
an ordering component that in response to a performance of at least one action, sends a request to a preparation monitor and a database to order the selected items, the request to the preparation monitor includes the selected items and the request to the database includes the selected items and the client data.

2. The client system of claim 1 wherein said client input further includes a card reader for simultaneously initializing a new order and for receiving the client data.

3. The client system of claim 1 wherein said dynamic imaging and dynamic texting display includes a touch screen display for selecting the selection items by touching the display and displaying selected items in a register receipt tabulated arrangement.

4. The client system of claim 1 further including a processing unit located remotely from said client input and said dynamic imaging and dynamic text display, said processing unit communicating with said client input and said dynamic imaging and dynamic text display through the internet.

5. A method of placing an order for an item the method comprising:
under control of a client system, activating the client system in response to a purchaser entering information;
displaying a distinctive arrangement of item options such that the item options are arranged in a hub and spoke arrangement for selection by the purchaser to create an order;
displaying selected items of the order in an arrangement such that the selected items are arranged in a register receipt tabulated arrangement; and
in response to an order from the purchaser, sending the order to a server system;
under control of a server system,
storing the purchaser information;
receiving the order;
generating an order to purchase the item; and
sending the order to a database and an order preparation monitor.

6. The method of claim 5 wherein said step of activating the client system in response to a purchaser entering information includes the step of reading a card having stored information unique to the purchaser, said method further including the step of storing the purchaser information and the order for use in connection with creating a sales report associated with the purchaser.

7. The method of claim 5 wherein said step of displaying selected items of the order in an arrangement such that the selected items are arranged in a register receipt tabulated arrangement further includes the steps of:
displaying a tab associated with each selected item for modifying the selected item;
displaying item options in a hub and spoke arrangement related to the selected item to be modified in response to the purchaser selecting the tab associated with the selected item.

8. The method of claim 5 wherein each of said arrangement of item options displayed in a hub and spoke arrangement represents a category of specific items and said method further includes the step of displaying category item options in a hub and spoke arrangement for selection by the purchaser, each of said category items being related to the selected item.

9. The method of claim 8 further including the step of displaying in a hub and spoke arrangement customization item options related to the selected category item, said customization item options being related to customizing the selected category item.

10. The method of claim 9 further including the step printing a receipt detailing said selections, including customization item options related to the selected category items and including a coupon for a future purchase based on purchaser information entered when activating the client system.

11. The method of claim 5 further including the step of under control of a client system, displaying permanently visible instructions.

12. The method of claim 5 further including the step of determining an order total in response to an input by the purchaser to complete the order, before ending the order to the server system.

13. The method of claim 12 further including the step of suggesting an item to the purchaser that will round up the order to an even dollar amount, before sending the order to the server system.

14. The method of claim 13 wherein said step of suggesting the item further includes the step of selecting the suggested item based on the selected items arranged in the register receipt tabulated arrangement.

15. The method of claim 5 further including the step of updating the client system information and items through the web without the need to recompile or recode the software used for generating the display of item options in a hub and spoke arrangement for selection.

16. A method of placing an order for an item the method comprising:
activating a kiosk user interface having a touch screen;
entering an order by touching the touch screen at predetermined locations arranged in a hub and a spoke arrangement;
modifying the order, if needed, by touching the order arranged in a register receipt tabulated arrangement; and
completing the order.

17. The method of claim 16 wherein kiosk user interface is activated by reading a card having stored information unique to a purchaser.

18. The method of claim 16 wherein said step of entering an order by touching the touch screen at predetermined locations further includes the steps of selecting a category of items by touching the touch screen, and displaying the category item options associated with the selected category in a hub and spoke arrangement in response to touching the touch screen.

19. The method of claim 18 wherein said step of entering an order by touching the touch screen at predetermined locations further includes the step of selecting category items from the displayed category item options by touching the screen at predetermined locations in a hub and spoke arrangement.

20. The method of claim 19 wherein said step of entering an order by touching the touch screen at predetermined locations further includes the step of displaying customized item options in a hub and spoke arrangement in response to said step of selecting category items, said customized item options being related to the selected category item.
